(19) United States
(12) Patent Application Publication
(10) Pub. No.: US 2006/0248820 A1
(43) Pub. Date: Nov. 9, 2006

(54) Integrally extruded glazing member for a sash assembly

(76) Inventor: Arthur Silverman, Warren, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/114,669

(22) Filed: Apr. 26, 2005

(51) Int. Cl. E06B 1/04

(52) U.S. Cl. 52/204.1

(57) ABSTRACT

A sash member for housing a glass unit for a window or door comprising a main body and a non-separable glazing member extruded together with said main body as a single unit. The glazing member moves between an unlocked position and a locked position relative to the main body. A hinge preferably connects the non-separable glazing member to the main body, so as to allow movement of the glazing member between the locked and unlocked positions.

### BACKGROUND OF THE INVENTION

The present invention relates to window and door sash assemblies, including sash assemblies for a fixed lite or picture window assembly. More particularly, the present invention relates to a sash assembly having a glazing member that is integrally extruded with the sash assembly in an open configuration.

A window or patio door sash assembly is typically comprised of a glass unit surrounded by a sash frame having horizontal sash members, referred to as sash rails, and vertical sash members, referred to as sash stiles. Once the framework of the sash members is connected together, the glass unit is placed therein. A glazing member, commonly referred to as a glazing bead, is then inserted into a receiving channel located within the sash members to provide a finished or more pleasing look to the window frame assembly. The glazing member is not typically needed to secure the glass unit within the window frame, but rather generally only serves an aesthetic purpose.

As shown in FIG. 1, a typical prior art glazing member 2 has an L-shaped body that is designed to fit into a receiving channel 3 located within a window sash member 4. Other shapes of glazing members can also be used, such as T-shaped or U-shaped. In the case of the L-shaped glazing member 2 shown in FIG. 1, the shorter horizontal leg 7 fits into the receiving channel 3, while the longer vertical leg 5 of the glazing member 2 is parallel to the back or glazing leg 6 of the sash member 2, and sits adjacent to the glass unit 8. A caulking material such as silicon is typically provided between the glazing leg 6 and the glass unit 8 to hold the glass unit 8 in position and to seal against water or dust entering between the glass unit 8 and the sash assembly 2.

There are several drawbacks associated with incorporating known glazing members into window or door sash assemblies. Many window and/or door sash assemblies require that the glazing member and sash member be extruded or molded as two separate pieces, and attached together after extrusion or molding of the sash member and glazing member. However, separately manufacturing the glazing member, and then attaching it to each of the sash members of the window or door sash framework requires a significant amount of time. Moreover, it often requires costly manual labor due to the need for workers to properly position the glazing member within a sash member and to secure it to the window or door sash framework.

Various methods and alternative window and/or door sash assemblies have been devised or created to address this problem. For example, U.S. Pat. No. 5,713,159 to Schmidt (“Schmidt”) discloses a plastic window sash member and glazing member that are extruded as one piece. More particularly, as shown in FIG. 2 hereof, the glazing member 12 and window sash member 14 are connected together along a ridge 19. Because the horizontal leg 16 of the glazing member 12 is designed to fit into the receiving channel 13, the glazing member 12 and sash member 14 must first be separated from one another along ridge 19 before the glazing member 12 is capable of being positioned within the receiving channel 13. There are still several drawbacks that result from constructing the Schmidt window assembly, however. For one, the glazing member 12 is not extruded in a position or configuration that is ready for installation. Rather, several steps are required before the glazing member 12 can be assembled with the window sash assembly. Namely, the glazing member 12 must be separated from the sash member 14, properly positioned to fit within the channel 13 of the window sash member 14, and then forced or otherwise inserted into the channel 13 to be retained thereon. The time it takes to cut away, remove, and then install the glazing member 12 into the window sash assembly can be a costly and added expense. Additionally, ensuring that the glazing member 12 is properly positioned so both ends of the glazing member 12 are flush with the window member sash requires additional time and the need for manual labor. Also, it is difficult with this arrangement to apply a caulking material against the glazing leg of the sash member 14. All of these factors cut down on production volume and serve to increase overall costs.

In view of the need to reduce manufacturing and assembly costs, including the elimination of the manual assembly of the glazing member 12 in a window or door sash assembly, it would therefore be beneficial to provide a new and improved window sash assembly that can be completely or substantially completely assembled by a machine.

### SUMMARY OF THE INVENTION

The present invention is designed to overcome or minimize the shortcomings associated with prior art window assemblies by providing an improved sash assembly for a window or door wherein the main body of a sash member is integrally extruded together with a corresponding glazing member as one piece, such that once the sash member is extruded and then assembled into a frame, the frame can receive a glass unit therein as well as immediately secure the glazing member to the main body of the sash member. In this regard, the sash assembly in accordance with the present invention does not require the separation of a glazing member prior to its insertion into the framework of sash members of a sash assembly.

In accordance with one aspect of the present invention, a sash member for housing a glass unit for a window or door comprises a main body and a non-separable glazing member extruded together with the main body as a single unit. The glazing member is constructed and arranged to move between an unlocked position and a locked position relative to the main body. Preferably, the glazing member is secured to the main body in the locked position when the glazing member is moved to the locked position. In a preferred embodiment of this aspect of the present invention, the glazing member is joined to the main body by means of an integral hinge which permits the movement of the glazing member between the unlocked and locked positions. Preferably, the integral hinge is a dual durometer hinge.

In accordance with an additional preferred feature of this aspect of the present invention, the main body includes an overhang having a lip, and the glazing member comprises a primary leg and a secondary leg so that the secondary leg engages the lip of the overhang when the glazing member is in the locked position.

In accordance with an additional preferred feature of this aspect of the present invention, the glazing member has a primary leg and a secondary leg that extends from the primary leg. The main body has a plurality of sides and a bridge that connects two of the plurality of sides, and an overhang having a lip. The overhang extends from one of the plurality of sides and across at least a portion of the bridge to create a recess. When the secondary leg is located within the recess and engages the lip, the secondary leg is secured to the main body.

In accordance with a further aspect of the present invention, there is provided a sash member for housing a glass unit for a window or door. The sash member has a main body; a glazing member attached to the main body and extruded together with the main body as a single unit; and an attachment member for attaching the glazing member to the main body. The main body, the glazing member, and the attachment member are extruded together as a single unit. This prevents the glazing member from being separated from the main body. The glazing member is in an open configuration relative to the main body and is capable of moving to a closed configuration relative to the main body. In a preferred embodiment, the attachment member is a hinge that is in an extended position when the glazing member is in the locked configuration, and in a bent position when the glazing member is in the unlocked configuration. Preferably, the hinge is a dual durometer hinge.

In accordance with another aspect of the present invention, there is provided a sash member for housing a glass unit for a window or door which comprises a main body and a glazing member. The glazing member is integrally attached to the main body along a hinged portion and is movable from an insertion position relative to the main body to a glazing position relative to the main body by folding along the hinged portion. Preferably, the glazing member has a locking member that can be inserted into a recess in the main body so that the glazing member can be locked or secured in the glazing position. More preferably, the locking member is a secondary leg that extends from the glazing member, and the main body further includes an overhang that extends across at least a portion of the bridge so as to create a recess for the secondary leg when the glazing member is in the glazing position.

In accordance with another aspect of the present invention, there is provided a sash assembly for housing a glass unit for a window or door which comprises a plurality of sash members and an insulated glass unit. At least one of the plurality of sash members has a main body and a non-separable glazing member integrally extruded with the main body of the sash member as a single unit. The glazing member is attached to the main body of the sash member by a hinge so that the glazing member is capable of moving from a first open position relative to the main body to a second closed position, relative to the main body.

Accordingly, various sash assemblies in accordance with the present invention are disclosed which overcome or minimize the shortcomings of the prior art. These and other features and characteristics of the present invention will be apparent from the following detailed description of preferred embodiments, which should be read in light of the accompanying drawings in which corresponding reference numbers refer to corresponding parts throughout the several views.

### BRIEF DESCRIPTION OF THE DRAWINGS

FIG. 1 is a cross-sectional perspective view of a prior art window sash member assembly showing a window sash member, a window sash glazing member and a window pane unit.

FIG. 2 is a cross-sectional view of another prior art window sash member and an integrally formed glazing member.

FIG. 3 is a cross-sectional view of a sash member and integral glazing member in accordance with the present invention, in which the glazing member is shown in an open configuration.

FIG. 4 is a cross-sectional view of the window sash member and integral glazing member shown in FIG. 3, in which the glazing member is shown in a partially closed configuration.

FIG. 5 is a cross-sectional view of the window sash member and integral glazing member shown in FIG. 3, in which the glazing member is shown in a fully closed configuration.

FIG. 6 is a perspective cross-sectional view of a portion of a window sash assembly in accordance with the present invention, in which the window pane unit is positioned within the frame and the glazing members are in their open configuration.

FIG. 7 is a perspective cross-sectional view of a portion of the window sash assembly shown in FIG. 6, but in which the glazing members are shown in their closed configuration.

FIG. 8. is a perspective view of a patio door assembly in accordance with the present invention, in which each of the sash members has an integral glazing member.

FIG. 9 is a perspective view of a portion of the patio door assembly shown in FIG. 8.

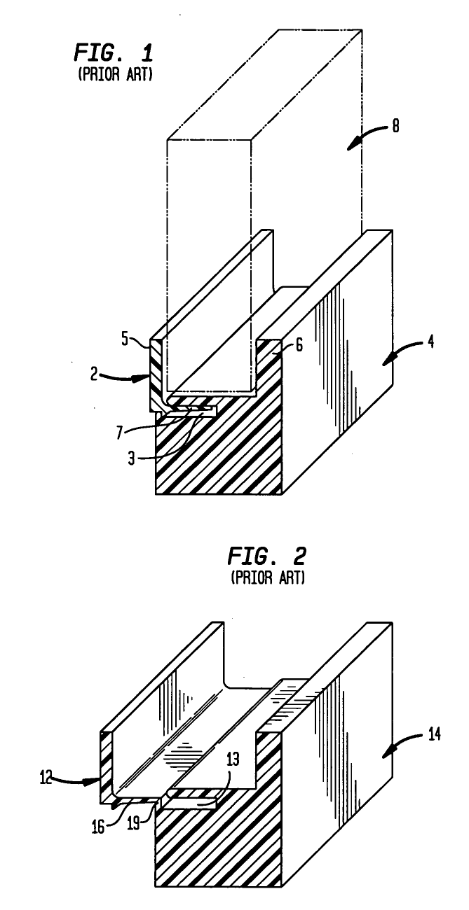

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected and it is to be understood that each specific term includes all technical equivalents which operate in the same or a similar manner to accomplish the same or a similar purpose.

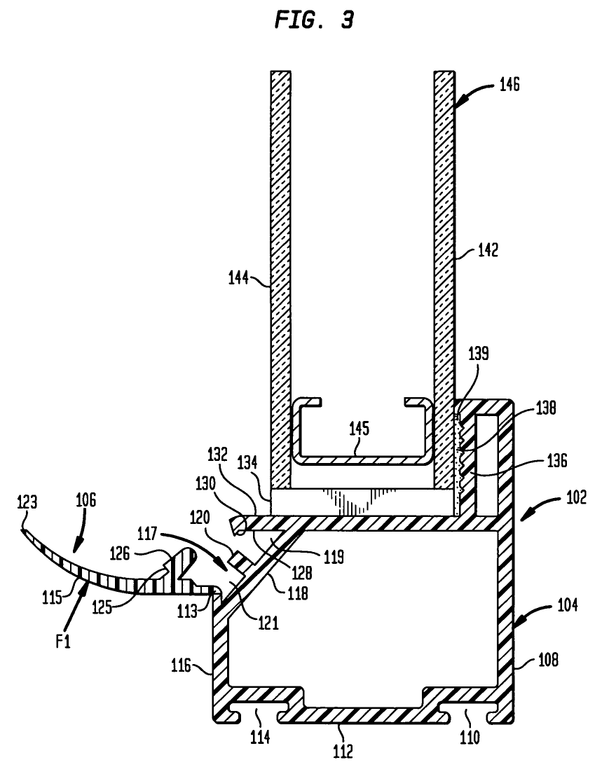

FIG. 3 illustrates one example of a portion of a sash assembly in accordance with the present invention. In a preferred embodiment, the sash assembly is a sash member for a window, although the sash member may also be used to construct a door, or a fixed lite or picture window assembly. For ease of discussion, the embodiments will be described with reference to a window.

The portion of the window sash assembly shown comprises a sash member 102 that further comprises a main body 104 having an integrally extruded glazing member 106 attached to it. As will be described in greater detail herein, once a framework (not shown) of sash members 102 is assembled together, an insulated glass unit 146 can be installed into the framework of sash members 102 to complete a window sash assembly. It should be appreciated that in accordance with the present invention, the sash member 102 can comprise either a horizontal sash member or a vertical sash member.

The main body 104 of the sash member 102 has a plurality of sides. In a preferred embodiment, there are four sides with a bridge. The first side 112 of the main body 104 is located on the side which is to be opposite the insulated glass unit 146. Channels 110, 114 may be incorporated into the first side 112 and are designed to receive insulation strips (not shown). The second side 108 of the main body 104 of the sash member 102 is preferably flat. The second side 108 includes a support wall 136 that extends beyond the third side 132. As will be described in fuller detail herein, the support wall 136 is used to support the insulted glass unit 146 that is to be installed into the sash member 102. Turning to the third side 132 of the sash member 102, the support wall 136 of the second side 108 is located at one end and an overhang 128 is located at the other end. A bridge member or section 118 extends between the fourth side 116 and the third side 132 of the sash member 102. Because the overhang 128 extends across a portion of the bridge member 118, a recess 117 is created between the third and fourth sides 116, 132. A locking stem 120 is preferably provided which is located on the bridge member 118 to divide the recess 117 into first and second recesses 119, 121. The final and fourth side 116 of the main body 104 is opposed to the second side 108. The preferably flat portion of the fourth side 116 does not extend the same distance as the second side 108, but rather terminates at the point where the glazing member 106 is attached to the sash member 102. As will be illustrated in further detail herein, however, when the glazing member 106 is in the closed configuration, the combined length of the fourth side 116 and the glazing member 106 will extend a distance that preferably corresponds to the overall height of the second side 108 of the main body 104.

The second primary component of the sash member 102 is the glazing member 106 which is integrally attached to one of the sides of the main body 104, namely the fourth side 116. The glazing member 106 is preferably comprised of a primary leg 115 that in its initial position, extends away from the fourth side 116 of the sash member 102. The primary leg 115 is preferably slightly curved and tapers from its widest point where it is connected to the main body 104 of the sash member 102 to a preferably angled tip 123. A secondary leg 126 also protrudes from the primary leg 115 at a point between the tip 123 of the glazing member 106 and the point where the primary leg 115 connects to the main body 104. The secondary leg 126 has a rounded end and a locking ledge 125 which, as will be described in greater detail herein, helps to secure the glazing member 106 to the main body 104 of the sash member 102 without the need for adhesives or additional materials.

The ability of the glazing member 106 to move from a first position to a second position is made possible through the use of a hinge that connects the glazing member 106 to the main body 104 of the sash member 102, thereby permitting the glazing member 106 to move from an open or unlocked configuration to a closed or locked configuration (and vice versa). The type of hinge used is preferably a dual durometer hinge 113. Dual durometer hinges are well known in the art, but are incorporated for the first time into a preferred embodiment of a sash member 102 in accordance with the present invention. Dual durometer hinges are typically formed using a coextrusion process. Coextrusion allows the hinge material to be partially formed from a softer material than the remainder of the sash member 102, namely, the main body 104 and the glazing member 106. Forming the hinge 113 from a softer material provides the dual durometer hinge 113 with enough flexibility to permit movement of the glazing member 106 from an open configuration to a closed configuration, but enough rigidity to prevent the glazing member 106 from easily breaking or being torn apart from the main body 104 of the sash member 102. A dual durometer hinge, such as the hinge disclosed in expired U.S. Pat. No. 4,463,046 issued to Hutchinson on Jul. 31, 1984, which is hereby incorporated herein by reference, can be implemented in accordance with the present invention, although other types of dual durometer hinges could instead be employed.

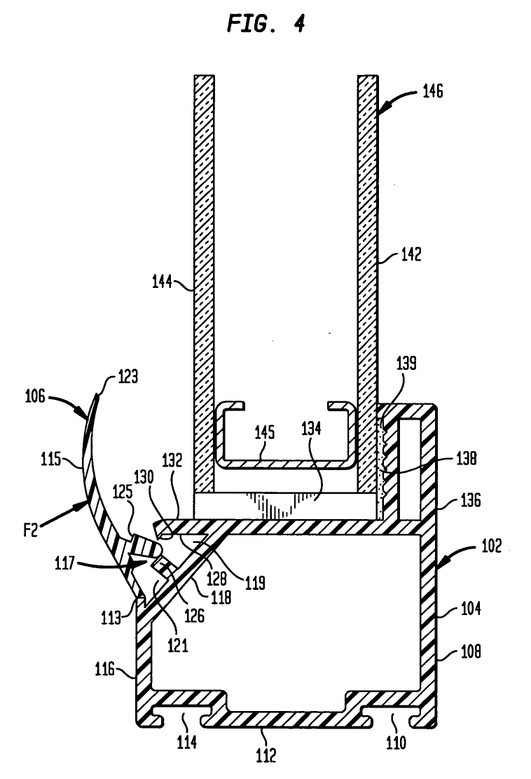

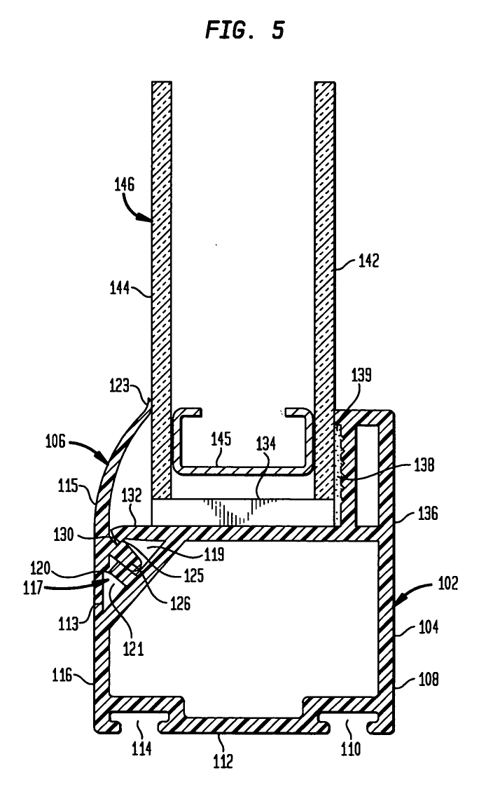

The glazing member 106 is adapted to move from its open or unlocked configuration to a closed or locked configuration when force is applied to the glazing member 106. More particularly, when a force F₁ is applied to the glazing member 106 in the general direction shown in FIG. 3, the glazing member 106 will begin to move or pivot from its open or unlocked configuration towards a closed or locked configuration. Referring to FIG. 4, the glazing member 106 is shown in a partially closed configuration. In this position, the glazing member 106 is positioned so that the secondary leg 126 of the glazing member 106 is positioned closer to the recess 117 of the main body 104 of the sash member 102. Although the flexibility of the dual durometer hinge 113 makes it is easy to position the secondary leg 126 at the entrance of the recess 117, in the preferred embodiment, unless an additional force F₂ is applied to the glazing member 106 to force the secondary leg 126 into the recess 117, and more particularly, the first recess 119 thereof, the secondary leg 126 will be unable to further advance into the first recess 119. When additional force F₂ is applied to the glazing member 106, the secondary leg 126 of the glazing member 106 will snap into the first recess 119 and into a closed configuration, such as shown in FIG. 5. It should be appreciated that two separate forces F₁ and F₂ are not required to move the glazing member 106 into a closed configuration, but are merely illustrated to demonstrate that a certain amount of force or pressure is required to snap the glazing member 106 into its final closed configuration. Thus, applying the appropriate amount of force to the glazing member 106 allows movement of the glazing member 106 to its closed or locked configuration.

Referring to FIG. 5, the glazing member 106 is illustrated in its fully closed or locked configuration. The force applied to the glazing member 106 causes the secondary leg 126 of the glazing member 106 to push past the end or lip 130 of the overhang 128 so that the locking ledge 125 of the secondary leg 126 engages the end or lip 130 of the overhang 128. The locking stem 120 on the bridge member 118 prevents further movement of the secondary leg 126 causing the secondary leg 126 to abut the locking stem 120. In this position, the glazing member 106 remains securely attached to the main body 104 of the sash member 102.

When the glazing member 106 is in its closed or locked configuration, the tip 123 of the glazing member 106 is partially deformed at the location where the tip 123 of the glazing member 106 contacts the insulted glass unit 146. As shown in FIG. 5, approximately 1/16″-⅛″ of the tip 123 becomes flattened. This excess amount of flattened material provides a greater surface area for the tip 123 of the glazing member 106 to contact the second side 144 of the insulated glass unit 146. Although not required, this provides a secondary means for securing the insulated glass unit 146 in place.

Once the locking ledge 125 of the secondary leg 126 of the glazing member 106 engages the lip 130, the glazing member 106 is secured closed. Another force (not illustrated) would be required if it is desired to remove the glazing member 106 away from and out of the recess 117 of the sash member 102.

The glazing member 106 is an important aspect in accordance with a preferred embodiment of the present embodiment. When using and assembling window sash members having glazing members 106 in accordance with the present invention, it is possible to substantially completely automate the process of assembling a fully completed sash assembly. Unlike the prior art, the glazing member 106 shown in FIG. 3 is preferably integrally extruded as part of the sash member 102. Extruding the glazing member 106 as part of the sash member 102 allows the glazing member 106 to be extruded together with the main body 104 of a sash member 102 in an open or unlocked configuration that is readily capable of receiving an insulated glass unit 146. The advantage of such a sash member 102 is that the integrally extruded glazing member 106 eliminates the need to first obtain (by cutting, separate extrusion or molding) a separate glazing member, and second, to manually position and secure the glazing member 106 into the recess 117 of the sash member 102. Substantially complete automation of the window sash assembly process is now possible because manual labor or the additional steps of positioning the glazing member 106, applying adhesive, and then inserting it into the sash member 102, are no longer necessary. Instead, the sash members 102 are extruded with the glazing member 106 in a first open or unlocked configuration, which will permit a machine to install an insulated glass unit 146. Thereafter, a machine can raise or move the glazing member 106 into its closed or locked position.

Preferably, the co-extrusion device uses a die head constructed and arranged so that the glazing member 106 will be extruded in its open or unlocked position, i.e. a position wherein the secondary leg 126 of the glazing member 106 and the lip 130 of the overhang 128 are not engaged with one another. Two streams of material are simultaneously fed through the die: a first stream of material that will form the main body portion and glazing member portions of the sash member 102 and a second stream of material having a different hardness that will form the dual durometer hinge 113 by which the glazing member 106 is attached to the main body 104. Typically, the primary machine, which feeds the harder material, and the smaller side machine, which feeds the softer material, run in tandem with one another so as to simultaneously feed the two streams through the die. Once the two materials exit the die, they are able to bond together without the need for adhesives or the like, thereby allowing the formation of a sash member 102 having the glazing member 106 positioned in an open configuration relative to the main body 104.

In a preferred embodiment, the first stream fed through the die is a polyvinyl chloride, and the secondary stream is a softer polyvinyl chloride. It should be appreciated, however, that there are various other combinations of material that may be used in accordance with the present invention.

When the newly bonded materials exit the die of the extrusion device, the device preferably cuts the material into an appropriate length of sash member 102. Furthermore, the ends of the sash members 102 are preferably cut at angles so that the respective ends of the sash members 102 may be joined to other sash members 102 in a complementary fashion to form a corner. One or more extrusion devices may be used to prepare and provide sash members 102 of appropriate size.

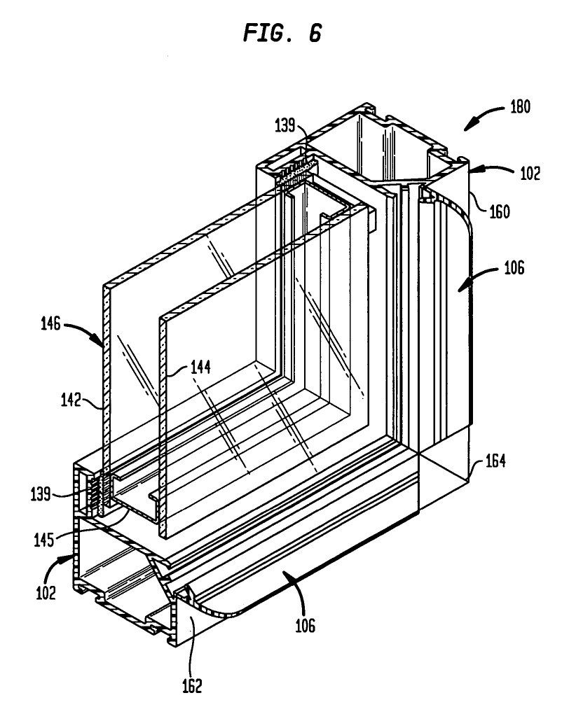

As illustrated and described herein, the sash members 102 are extruded so that the glazing members 106 are in their open or unlocked configuration. Referring to FIG. 6, once the individual sash members 102 are formed, they are joined at the corners in a suitable manner, such as by mitering and welding them together into the shape of a window frame. Similarly, as shown in FIG. 6, the ends 164 of the glazing members are not cut straight, but are angled or mitered. Once the sash members 102 are connected together, a frame 180 having glazing members 106 in their open configuration is formed, wherein the glazing members 106 of the sash stiles 160 (also referred to as sash members) and sash rails 162 (also referred to as sash members) are in an open configuration that allows an insulated glass unit 146 to be placed directly into the frame. The insulated glass unit 146 has first and second sides 142,144 and is preferably comprised of two glass panes and a spacer 145 located between the two glass panes. (See FIG. 3.) It should be appreciated that the insulated glass unit 146 may be constructed and arranged in accordance with known methods of constructing window panes.

More particularly, when the sash members 102 are assembled together as a frame 180, such as by mitering and welding, the inner surface of each of the support walls 136 is provided with a bead 139 of caulking material, such as silicon. This bead 139, as best seen in FIGS. 3-5, is commonly referred to as a back bedding. The back bedding 139 preferably extends completely about the periphery of the frame 180 (see FIG. 6.) The insulated glass unit 146 is then placed within the frame 180 so that it rests against the back bedding 139 of caulking material provided on the support walls 136 of the main body members 104 about the periphery of the frame 180. The back bedding 139 of silicon or other caulking material serves to hold the insulating glass unit 146 in place, and to provide a seal against water, dirt and dust from entering between the insulating glass unit 146 and the support wall 136 of the sash members 102. In essence, the back bedding 139 fills the space between the insulating glass unit 146 and the support walls 136. Preferably, ridges 138 are provided on the inner surface of each support wall 136 to provide an increased surface area so that the back bedding 139 will remain in place. (See FIGS. 3 and 6.)

As best seen in FIGS. 3-5, the insulated glass unit 146 is preferably positioned so that the edges of the insulated glass unit 146 do not contact the third sides 132 of the sash members 102. In the preferred embodiment, this is accomplished by placing a plurality of bumpers 134 on the third sides of the main bodies 104 of the sash members about all four sides of the frame 180. The bumpers 134 are 1/16″-⅛″ thick, and at least two bumpers 134 are used per sash member 102. Positioning the insulated glass unit 142 away from the third sides 132 of the sash members 102 (i.e., sash rail or sash stile) prevents the insulated glass unit 146 from prematurely cracking or breaking due to stress or undue pressure from the sash members 102.

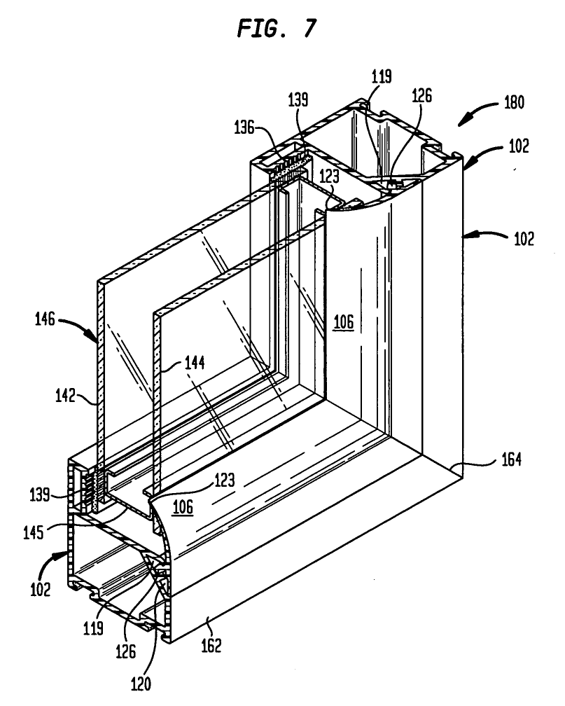

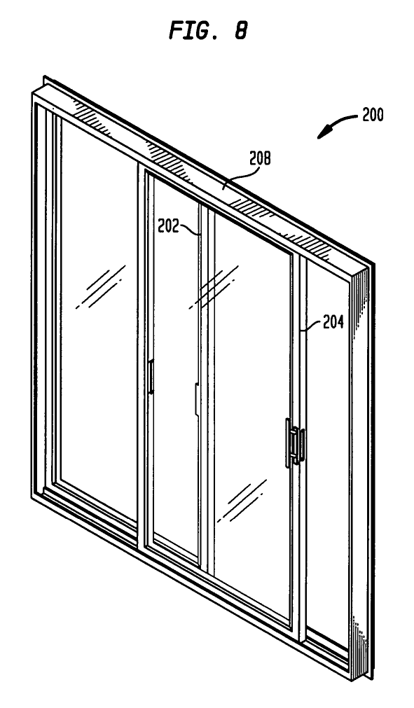

Referring to FIG. 7, once the insulated glass unit 146 is positioned within the window frame 180, the respective glazing members 106 may be moved or pivoted to their closed or locked position, wherein the secondary legs 126 are located within the respective first recesses 119. In the closed positions, the glazing members 106 cause the length of the fourth sides 116 of the main body members 104 and the glazing members 106 to approximately equal the length of the second sides 108 of the main bodies 104. (See FIGS. 5 and 7.) Furthermore, in the preferred embodiment, the tips 123 of the glazing members 106 will be located approximately at the same height as the spacers 145 located in the insulated glass unit 146. This is best seen in FIG. 5.

It should be appreciated that sash members 102 in accordance with this invention may be assembled together to form a frame 180 (FIG. 6) using known methods of assembly, such as welding or the use of screws. The method of assembling sash members 102 in accordance with the present invention is therefore not limited to the steps disclosed herein, but could encompass all known methods of window assembly.

As described herein, assembly of a window sash assembly in accordance with the present invention makes it possible to achieve substantially complete automation of the window assembly process. Once the window sash members 102 are extruded, a machine can assemble each of the window sash members 102 into the shape of a frame 180. Because the glazing members 106 remain in their original open configuration once the frame 180 is assembled, a machine can apply the back bedding 139 of caulking material to the support walls 136 of the sash member 102. Once the back bedding 139 is applied, and the insulated glass unit 146 is placed thereagainst in the window sash assembly, the insulated glass unit 146 will rest and be secured against or adjacent the support walls 136 of the main bodies 104 of the sash members 102. See FIGS. 3 and 6. The glazing members 106 may then be moved from their open configurations to their closed configurations, best shown in FIGS. 5 and 7, by a machine arm or arms. Thus, the assembly process in accordance with the present invention can eliminate or at least minimize the need for manual assembly of the window sash assembly, and significantly reduce the cost and time for manufacturing window or door sash assemblies.

It should be appreciated that the teachings herein are equally applicable for constructing door assemblies, such as the patio door assembly 200 shown in FIG. 8. Typical one or two-door patio door assemblies, such as shown in FIG. 8, are approximately 5 to 8 feet in width and 6 to 8 feet in height, such that each patio door panel is approximately 2.5 to 4 feet wide. The patio door assemblies may have one fixed door panel and one moveable door panel, or may have two moveable door panels. In FIG. 8, there is an outer frame 201 with one fixed patio door panel 202, and an inner movable patio door panel 204 which is slidable relative to the fixed frame 200 and fixed patio door panel 202.

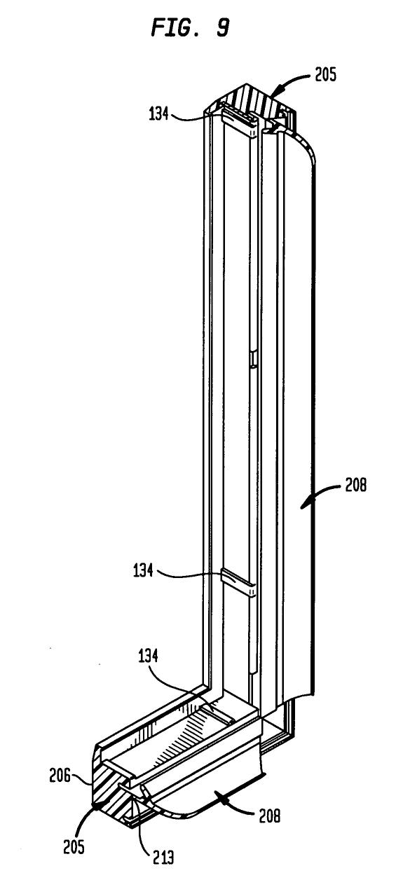

FIG. 9 shows a portion of the movable patio door 204 without the glass unit 146. The movable patio door 204 is very similar to the window sash assembly previously described herein. The door sash members 205 each have a main body 206 and a glazing member 208 attached to the main body 206 by a dual durometer hinge 213. The main body 206 may have a reinforcing bar 207 thereon, in accordance with the teaching of applicant's pending application U.S. Ser. No. 10/953,385 filed Sep. 29, 2004, the disclosure of which is hereby incorporated by reference. The glazing member 208 can be constructed and arranged in accordance with the teachings described herein. The glazing members 208 are therefore capable of moving from an open position to a closed position, and can be secured to the main bodies 206 through use of a locking mechanism, such as described hereinabove for the window sash members 102.

Although the invention herein has been described with reference to particular embodiments and preferred dimensions or ranges of measurements, it is to be understood that these embodiments are merely illustrative of the principles and applications of the present invention. Additionally, it is to be appreciated that the present invention may take on various alternative orientations. It is therefore to be understood that numerous modifications may be made to the illustrative embodiments and that other arrangements may be devised without departing from the spirit and scope of the present invention as defined by the appended claims.

1. A sash member for housing a glass unit comprising a main body and a non-separable glazing member extruded together with said main body as a single unit, said glazing member constructed and arranged to move between an unlocked position and a locked position relative to said main body.

2. The sash member of claim 1, wherein said glazing member is secured to said main body when said glazing member is in said locked position.

3. The sash member of claim 1, further comprising an integral hinge joining said glazing member to said main body, and wherein said integral hinge permits said movement of said glazing member between said unlocked position and said locked position relative to said main body.

4. The sash member of claim 3, wherein said integral hinge is in an extended position when said glazing member is in said locked position, and wherein said integral hinge is in a bent position when said glazing member is in said unlocked position.

5. The sash member of claim 3, wherein said integral hinge is a dual durometer hinge.

6. The sash member of claim 1, wherein said main body comprises an overhang having a lip, and said glazing member comprises a primary leg and a secondary leg, said glazing member being in said locked position when said secondary leg of said glazing member engages said lip of said overhang of said main body.

7. The sash member of claim 1, wherein said sash member is comprised of polyvinyl chloride.

8. The sash member of claim 1, wherein said glazing member and said main body are extruded together as one piece so that at the conclusion of the extrusion process, said glazing member is in said unlocked position.

9. The sash member of claim 1, wherein said glazing member is extruded so as to be in said unlocked position prior to installation of a glass unit and capable of moving to said locked position after installation of said glass unit.

10. The sash member of claim 8, wherein said glazing member when in said unlocked position extends outwardly from said main body and wherein said glazing member when in said locked position is adjacent a glass unit installed in said sash member.

11. The sash member of claim 8, wherein said sash member further includes a locking mechanism for securing said glazing member to said main body when said glazing member is in said locked position.

12. The sash member of claim 11, wherein said locking mechanism comprises a secondary leg attached to said glazing member and means for securing said secondary leg to said main body.

13. The sash member of claim 12, wherein said means for securing comprises an overhang on said main body, said overhang having a lip capable of engaging said secondary leg of said glazing member.

14. The sash member of claim 11, wherein said locking mechanism comprises a secondary member extending from said main body of said sash member, and an engaging member on said glazing member, and said glazing member is in said locked position when said secondary member and said engaging member engage one another.

15. The sash member of claim 1, wherein said glazing member further comprises a primary leg and a secondary leg extending from said primary leg,
said main body has a plurality of sides and a bridge connecting two of said plurality of sides, and an overhang which has a lip, said overhang extending from one of said sides and across at least a portion of said bridge so as to create a recess with said bridge, and
said secondary leg of said glazing member is secured to said main body when said secondary leg is located within said recess so as to engage said lip.

16. The sash member of claim 15, further comprising a hinge, said hinge connecting said glazing member to said main body and permitting movement of said glazing member from an open position to a closed position.

17. The sash member of claim 16, wherein said hinge is a dual durometer hinge.

18. The sash member of claim 1, wherein said sash member is window sash member.

19. The sash member of claim 1, wherein said sash member is a door sash member.

20. A sash member for housing a glass unit, said sash member comprising a main body, a glazing member, and an attachment member for attaching said glazing member to said main body, said main body, said glazing member, and said attachment member being extruded together as a single unit, so that said glazing member is non-separable from said main body and said glazing member is in an open configuration relative to said main body and is capable of moving to a closed configuration relative to said main body.

21. The sash member of claim 20, wherein a portion of said glazing member remote from said attachment member is secured to said main body when said glazing member is in said closed configuration.

22. The sash member of claim 20, wherein said attachment member is a hinge, said hinge being in an extended position when said glazing member is in said closed configuration, and said hinge being in a bent position when said glazing member is in said open configuration.

23. The sash member of claim 22, wherein said hinge is a dual durometer hinge.

24. The sash member of claim 23, wherein said main body and said glazing member are comprised of polyvinyl chloride.

25. The sash member of claim 24, wherein said polyvinyl chloride is a first polyvinyl chloride, and said dual durometer hinge is formed from a second polyvinyl chloride, said first polyvinyl chloride having a hardness that is greater than said second polyvinyl chloride.

26. The sash member of claim 20, wherein said main body comprises an overhang having a lip, and said glazing member comprises a primary leg and a secondary leg, said glazing member being in said closed configuration when said secondary leg of said glazing member engages said lip of the overhang.

27. The sash member of claim 20, wherein said sash member is a window sash member.

28. The sash member of claim 20, wherein said sash member is a door sash member.

29. A sash assembly comprising a plurality of sash members and an insulated glass unit, at least one of said plurality of sash members having a main body and a non-separable glazing member integrally extruded with said main body of said sash member as a single unit, said glazing member being attached to the main body of the sash member by a hinge so that said glazing member is capable of moving from a first, open position to a second, closed configuration.

30. A sash member comprising a main body and a glazing member, said glazing member being integrally attached to said main body along a hinged portion and movable from an insertion position to a glazing position by folding along said hinged portion.

31. The sash member according to claim 30, wherein said main body has a recess and said glazing member has a locking member insertable into said recess in said main body so as to lock said glazing member in said glazing position.

32. The sash member according to claim 31, wherein said locking member comprises a secondary leg extending from said glazing member, and wherein said main body further includes an overhang defining a recess within said main body, and said glazing member being in said glazing position when said secondary leg is located within said recess of said main body and engages said overhang.

33. The sash member of claim 20, wherein said sash member is a window sash member.

34. The sash member of claim 20, wherein said sash member is a door sash member.
